(19) United States
(12) Patent Application Publication
(10) Pub. No.: US 2012/0112632 A1
(43) Pub. Date: May 10, 2012

(54) FLASH DISCHARGE TUBE ELECTRODE AND FLASH DISCHARGE TUBE

(75) Inventors: Hiroshi Saiki, Kyoto (JP); Kosei Hotta, Kyoto (JP)

(73) Assignee: Panasonic Corporation, Osaka (JP)

(21) Appl. No.: 13/383,694

(22) PCT Filed: Aug. 23, 2010
(86) PCT No.: PCT/JP2010/005165

§ 371 Date: Jan. 12, 2012

(30) Foreign Application Priority Data
Aug. 24, 2009 (JP) 2009-192814

(51) Int. Cl. H01J 61/36

(52) U.S. Cl. 313/623

(57) ABSTRACT

A flash discharge tube electrode sealed to the end of the glass bulb of a flash discharge tube includes an internal electrode led into the glass bulb; a sintered electrode structure connected to the top end of the internal electrode, with an external diameter equal to or smaller than that of the internal electrode, and a projection made of a high-melting-point metal, provided so as to partially project from the top end face of the sintered electrode structure.

### TECHNICAL FIELD

The present invention relates to a flash discharge tube used as a rod-shaped, artificial source for photographing for example and to a flash discharge tube electrode included in the tube.

### BACKGROUND ART

As shown in FIG. 3, a conventional flash discharge tube has the following configuration. One end of glass bulb 1 made of borosilicate glass has anode electrode 3 sealed thereto through bead glass 2. The other end of glass bulb 1 has cathode electrode 4 sealed thereto through bead glass 2. The entire outer circumferential surface of glass bulb 1 is provided thereon with trigger electrode 5 made of a transparent, conductive coating. A noble gas such as xenon is filled in glass bulb 1.

Anode electrode 3 includes internal electrode 6 (made of tungsten for example) led into glass bulb 1 and external electrode 7 (made of nickel for example) led out of glass bulb 1. Anode electrode 3 is formed of a rod-shaped, joined metallic body produced by welding internal electrode 6 and external electrode 7 in series.

Cathode electrode 4 includes internal electrode 8 (made of tungsten for example) led into glass bulb 1 and external electrode 9 (made of nickel for example) led out of glass bulb 1. Cathode electrode 4 is formed of joined metallic body produced by welding internal electrode 8 and external electrode 9 in series. Inside glass bulb 1, sintered electrode structure 10 is fixed near the top end of internal electrode 8.

Sintered electrode structure 10 is provided to flash. Cathode electrode 4 is formed so that internal electrode 8 penetrates sintered electrode structure 10, and swages sintered electrode structure 10, resulting in internal electrode 8 fixed thereto.

In the meantime, downsizing imaging devices have been highly demanded in recent years as well as downsizing flash discharge tubes used therefor. To downsize a flash discharge tube, bead glass 2 and sintered electrode structure 10 must have smaller diameter.

However, a smaller diameter of sintered electrode structure 10 makes its wall thickness smaller, resulting in sintered electrode structure 10 easily broken when swaged. Consequently, making the diameter of sintered electrode structure 10 smaller is assumed to be limited. Meanwhile, making the diameter of internal electrode 8 penetrating sintered electrode structure 10 excessively smaller causes a shorter life due to discharge.

As a result, patent literature 1 describes the following flash discharge tube. That is, the top end of a lead wire (corresponding to internal electrode 8 of cathode electrode 4 in the flash discharge tube) is butt-joined in series to an electrode element (corresponding to sintered electrode structure 10 of cathode electrode 4 in the flash discharge tube) with a diameter equal to or smaller than that of the lead wire, and then they are combined together by welding to produce the flash discharge tube. The electrode element has a height of at least 1.2 mm, which allows the element to be grasped when welded onto the lead wire without the element diffusing excessive heat. The electrode element (sintered electrode structure) is retained to the internal electrode by welding instead of swaging, which does not require the sintered electrode structure to penetrate the internal electrode. As a result, the internal electrode can be designed so that its diameter is thicker. Consequently, the size of the sealed area between the internal electrode and glass expands, allowing the sealing strength to be increased, which facilitates securing the reliability at the sealed area in making the diameter smaller.

As sintered electrode structure 10, the following product is devised. That is, one or more kinds of metal powder made of a high-melting-point metallic material (e.g. tantalum, niobium, zirconium, nickel) are mixed to generate a sintered body, and the sintered body retains an electron emission material. The electron emission material is a cesium compound so that the flash discharge tube emits a large amount of electrons instantaneously.

To produce such sintered electrode structure 10, a sintered body is immersed in a solution of a cesium compound in water or alcohol, and then dried. The sintered body has various sizes of holes formed therein, and thus the holes are impregnated with the solution of a cesium compound.

When such sintered electrode structure 10 (a sintered body retaining a cesium compound) is used as the electrode element of the flash discharge tube described in patent literature 1, the cesium compound is not activated. Meanwhile, the electrode element of the flash discharge tube described in patent literature 1 exposes its top end face, and thus ion collision caused by discharge concentrates on the top end face, which causes the electrode element to melt and the glass bulb near the electrode element to crack, shortening the life.

### CITATION LIST

### Patent Literature

PTL 1 Japanese Translation of PCT Publication No. 1985-502028

### SUMMARY OF THE INVENTION

The present invention provides a flash discharge tube electrode that is a cathode electrode aiming at a smaller diameter and longer life, and a flash discharge tube including the flash discharge tube electrode.

A flash discharge tube electrode of the present invention is a flash discharge tube electrode sealed to the end of the glass bulb of the flash discharge tube. The electrode includes an internal electrode led into the glass bulb; a sintered electrode structure connected to a top end of the internal electrode, with an external diameter equal to or smaller than that of the internal electrode; and a projection made of a high-melting-point metal, provided so as to partially projects from the top end face of the sintered electrode structure.

This flash discharge tube electrode, in which a projection made of a high-melting-point metal is provided so as to partially projects from the top end face of the sintered electrode structure, has a structure that prevents the amount of colliding ions from concentrating on a unit area of the discharge surface of the sintered electrode when discharging. Consequently, even the sintered electrode structure with a smaller diameter does not cause the glass bulb to crack.

### BRIEF DESCRIPTION OF DRAWINGS

FIG. 1 is an outline cross-sectional front view of a flash discharge tube according to an embodiment of the present invention.

FIG. 2A is an outline cross-sectional front view of a flash discharge tube electrode according to the embodiment of the present invention.

FIG. 2B is an outline cross-sectional front view of a flash discharge tube electrode according to the embodiment of the present invention.

FIG. 2C is an outline cross-sectional front view of a flash discharge tube electrode according to the embodiment of the present invention.

FIG. 2D is an outline cross-sectional front view of a flash discharge tube electrode according to the embodiment of the present invention.

FIG. 3 is an outline cross-sectional front view showing an example of a conventional flash discharge tube.

### DESCRIPTION OF EMBODIMENTS

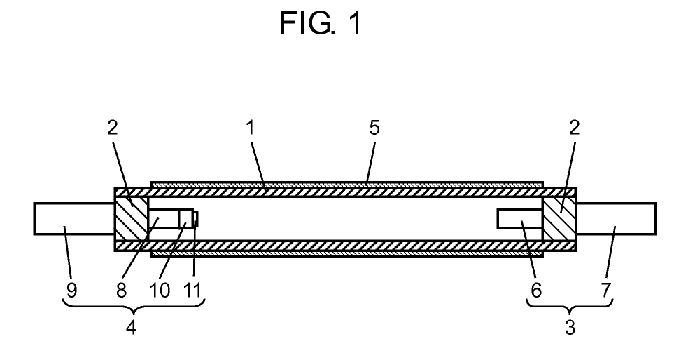

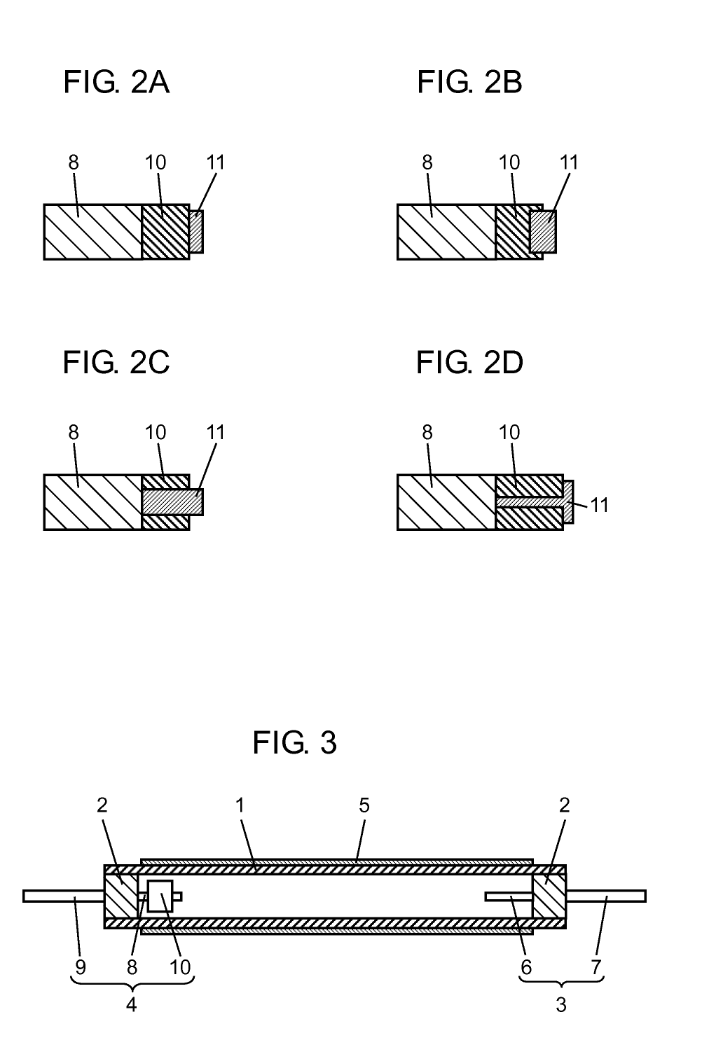

A description is made of a flash discharge tube electrode and a flash discharge tube according to an embodiment of the present invention, referring to FIGS. 1 and 2. A component the same as that of a conventional one is given the same reference mark for description.

The flash discharge tube of the embodiment has the following configuration. One end of glass bulb 1 made of borosilicate glass has anode electrode 3 sealed thereto through bead glass 2. The other end of glass bulb 1 has cathode electrode 4 sealed thereto through bead glass 2. The entire outer circumferential surface of glass bulb 1 is provided thereon with trigger electrode 5 made of transparent, conductive coating. A noble gas such as xenon is filled in glass bulb 1.

Anode electrode 3 includes internal electrode 6 (made of tungsten for example) led into glass bulb 1 and external electrode 7 (made of nickel for example) led out of glass bulb 1. Anode electrode 3 is formed of a rod-shaped, joined metallic body produced by welding internal electrode 6 and external electrode 7 in series.

Cathode electrode 4 includes internal electrode 8 (made of tungsten for example) led into glass bulb 1 and external electrode 9 (made of nickel for example) led out of glass bulb 1. Cathode electrode 4 is formed of a joined metallic body produced by welding internal electrode 8 and external electrode 9 in series. Inside glass bulb 1, sintered electrode structure 10 is fixed near the top end of internal electrode 8.

Further, cathode electrode 4 of the embodiment has projection 11 so as to partially projects from the top end face of sintered electrode structure 10. Projection 11 is formed of a high-melting-point metal such as tungsten, molybdenum, tantalum, and niobium. Projection 11 is fixed to the top end face of sintered electrode structure 10 so that the area size of the top end face of projection 11 is approximately 20% to 60% of the top end face of sintered electrode structure 10. In other words, projection 11 is provided near the top end of sintered electrode structure 10 so as to cover 20% to 60% of the top end face of sintered electrode structure 10.

Sintered electrode structure 10 is produced by immersing a sintered body generated by sintering a high-melting-point metal such as tantalum and niobium in a solution of a cesium compound in water or alcohol. Accordingly, sintered electrode structure 10 is a substance that retains an electron radiation material made of a cesium compound such as cesium carbonate, cesium sulfate, cesium oxide, and cesium niobate.

The sintered body, having holes formed therein, is produced by being uniformly impregnated with a moderate amount of cesium compound so that, for example, the porosity is 28% to 36% by volume; and hole diameters (measured by mercury press-in method) are distributed between 0.75 to 2.70 μm with a peak between 1.4 to 1.8 μm.

Internal electrode 8 is fixed to sintered electrode structure 10 by welding for example. Sintered electrode structure 10 has an external diameter equal to or smaller than that of internal electrode 8.

Projection 11 can be shaped differently as shown in FIGS. 2A through 2D. Projection 11 shown in FIG. 2A is formed in a thin piece and stacked onto the top end face of sintered electrode structure 10. Projection 11 is fixed to sintered electrode structure 10 by welding. Accordingly, projection 11 is formed on the top end face of sintered electrode structure 10.

Projection 11 shown in FIG. 2B is formed in a thick piece and partially embedded in sintered electrode structure 10. The top end face of sintered electrode structure 10 shown in FIG. 2B has a depressed part formed therein into which nearly a half of projection 11 is embedded. Projection 11 is embedded in the depressed part of sintered electrode structure 10 by nearly a half of its thickness. Projection 11 is fixed to sintered electrode structure 10 by welding.

Projection 11 shown in FIG. 2C is embedded in sintered electrode structure 10 deeply enough to reach internal electrode 8. At the same time, projection 11 is formed in a column shape with its external diameter constant throughout its total length. In other words, projection 11 is partially embedded in sintered electrode structure 10 to contact internal electrode 8.

Projection 11 shown in FIG. 2D is embedded in sintered electrode structure 10 deeply enough to reach internal electrode 8. In other words, projection 11 is partially embedded in sintered electrode structure 10 to contact internal electrode 8. Further, projection 11 is formed so that the external diameter of the part of projection 11 embedded in sintered electrode structure 10 is smaller than that of the part exposed from the top end face of sintered electrode structure 10. In other words, projection 11 is formed so that its cross section is T-shaped.

Hence, each of sintered electrode structures 10 shown in FIGS. 2C and 2D has a through-hole formed on the central axis. The internal diameter of the through-hole of sintered electrode structure 10 shown in FIG. 2C is made larger than that in FIG. 2D. Projections 11 shown in FIGS. 2C and 2D are in contact with the top end face of internal electrode 8. Consequently, projection 11 may be fixed to internal electrode 8 by such as welding.

In any structure shown in FIG. 2A to 2D, sintered electrode structure 10 is fixed to internal electrode 8 without being broken. Cathode electrode 4 composed of sintered electrode structure 10 provided with projection 11 on its top end face, internal electrode 8, and external electrode 9 can make the diameter of glass bulb 1, thus a flash discharge tube, smaller.

The flash discharge tube of the embodiment is provided with projection 11 on the top end face of sintered electrode structure 10. Consequently, the amount of ions can be reduced that collide with a unit area of the discharge surface of the sintered electrode when discharging without concentrating. This prevents glass bulb 1 from cracking and extends the life of the flash discharge tube.

Meanwhile, sintered electrode structure 10 retains a cesium compound, which further reduces sputtering to stabilize the lowest light-emitting voltage and light amount. Further, this prevents the sintered electrode from melting more effectively.

As shown in FIGS. 2C and 2D, in a case where projection 11 is in contact with internal electrode 8, heat transmits as far as projection 11 when bead glass 2 seals internal electrode 8, which activates the emitter to lower the lighting voltage.

Projection 11 is preferably projects by 0.1 to 0.3 mm from the top end face of sintered electrode structure 10.

Hereinafter, a description is made of measured values of the lighting voltage and light amount referring to table 1 in the cases where projection 11 is not provided and the projection length of projection 11 is 0.1 mm, 0.2 mm, 0.3 mm, and 0.4 mm.

TABLE 1

| | | | | | | | | | Cracks | |
|---|---|---|---|---|---|---|---|---|---|---|
| Projection | Lighting voltage | | | | Light amount | | | | in | |
| length | Initial | | Life | | Initial | | Life | | appearance | Note |
| 0.0 mm | 200 V | ∘ | 240 V | x | 98.5% | ∘ | 94.5% | x | 5 | Large amount of |
| | (95.2%) | | (114.3%) | | | | (5.5%) | | | melting/flying of |
| | | | | | | | | | | sintered electrode |
| | | | | | | | | | | structure, |
| | | | | | | | | | | many cracks in |
| | | | | | | | | | | glass bulb near |
| | | | | | | | | | | electrode, |
| | | | | | | | | | | large decrease |
| | | | | | | | | | | in light amount |
| 0.1 mm | 210 V | ∘ | 220 V | ∘ | 100% | ∘ | 97.6% | ∘ | 0 | — |
| | (100%) | | (104.8%) | | | | (2.4%) | | | |
| 0.2 mm | 210 V | ∘ | 215 V | ∘ | 100% | ∘ | 97.3% | ∘ | 0 | — |
| | (100%) | | (102.4%) | | | | (2.7%) | | | |
| 0.3 mm | 215 V | ∘ | 225 V | ∘ | 100% | ∘ | 97% | ∘ | 0 | — |
| | (102.4%) | | (107.1%) | | | | (3%) | | | |
| 0.4 mm | 230 V | x | 250 V | x | 101.0% | ∘ | 95% | x | 2 | Large amount of |
| | (109.5%) | | (119%) | | | | (5%) | | | melting of |
| | | | | | | | | | | projection, |
| | | | | | | | | | | large rate of |
| | | | | | | | | | | climb of lighting |
| | | | | | | | | | | voltage after life |

Each measured value in the table is that measured under the following concrete conditions.

A flash discharge tube used for measurement has an external diameter of 1.8 mm (internal diameter of 1.2 mm) and an inter-electrode path of 14 mm.

A test is performed by measuring the lighting voltage and light amount and by visually observing the appearance of the glass bulb. This test is performed at the initial state and after the life test (light is emitted 3,000 times at 30-second intervals). The results are shown in table 1 under “Initial” and “Life”. The capacitor for charging emission energy has a capacitance of 80 μF and a charging voltage of 310 V, where the measurement is made under these conditions. The tested quantity n is 10 for each condition. The lighting voltage refers to the lowest voltage at which light is emitted 10 times sequentially at 3-second intervals. The light amount refers to that of one-time light emission, where the initial light amount of a piece with its projection length of 0.2 mm is assumed 100%. In the table, the projection length of 0.0 mm means that a projection is not provided. In the following description of the table, “life time (life end)” refers to a time point after a life test has been performed.

Table 1 provides most favorable values of the initial lighting voltage in a case where the projection length of projection 11 is 0.3 mm or smaller and projection 11 is not provided. Meanwhile, in a case where the projection length of projection 11 is 0.4 mm, table 1 shows that an impractically high voltage is required.

The lighting voltage at a life time becomes favorable in a case where the projection length of projection 11 is 0.1 mm, 0.2 mm, and 0.3 mm. Meanwhile, in a case where projection 11 is not provided (0.0 mm) or the projection length of projection 11 is 0.4 mm, table 1 shows that an impractically high voltage is required as a lighting voltage at a life time.

The high lighting voltage at a life time when the projection length of projection 11 is 0.4 mm is supposedly because of a larger meltage of projection 11 due to the projection length longer than the other cases.

Next, the initial light amount is found favorable in whichever case of the projection length of projection 11. The light amount at a life time becomes favorable when the projection length is 0.1 mm, 0.2 mm, and 0.3 mm. Meanwhile, when projection 11 is not provided (0.0 mm) or the projection length is 0.4 mm, only an impractically low level of light amount (i.e. too dark to use) is provided.

Next, the number of cracks in appearance is zero when the projection length is 0.1 mm, 0.2 mm, and 0.3 mm; five, when projection 11 is not provided (0.0 mm); and two when 0.4 mm.

The low light amount at a life time when projection 11 is not provided (0.0 mm) is supposedly because the melting and flying amount of sintered electrode structure 10 increases to cause a large number of cracks in glass bulb 1 near the flash discharge tube electrode.

From the above situations, judgement can be made that sintered electrode structure 10 can be used favorably when the projection length of projection 11 is 0.1 mm, 0.2 mm, and 0.3 mm; unfavorably, when projection 11 is not provided (0.0 mm) or 0.4 mm.

The present invention is not limited to the embodiment, but can be modified in various ways. For example, in the embodiment, a cesium compound is used for an electron radiation material retained by sintered electrode structure 10; however, another compound may be used. Further, the porosity of the sintered body, hole diameter, and the distribution of hole diameters are not limited to those described in the embodiment.

### INDUSTRIAL APPLICABILITY

A flash discharge tube electrode and a flash discharge tube including the flash discharge tube electrode can be effectively used for a component of a flash as an artificial source.

### REFERENCE MARKS IN THE DRAWINGS

1 Glass bulb
2 Bead glass
3 Anode electrode
4 Cathode electrode (flash discharge tube electrode)
5 Trigger electrode
6 Internal electrode
7 External electrode
8 Internal electrode
9 External electrode
10 Sintered electrode structure
11 Projection

1. A flash discharge tube electrode sealed to an end of a glass bulb of a flash discharge tube, comprising:
an internal electrode led into the glass bulb;
a sintered electrode structure connected to a top end of the internal electrode, with an external diameter equal to or smaller than an external diameter of the internal electrode; and
a projection made of a high-melting-point metal, provided so as to partially project from a top end face of the sintered electrode structure.

2. The flash discharge tube electrode of claim 1, wherein the projection projects to a thickness of 0.1 to 0.3 mm from the top end face.

3. The flash discharge tube electrode of claim 1, wherein the projection is provided on the sintered electrode structure so as to cover 20% to 60% of an area size of the top end face.

4. The flash discharge tube electrode of claim 1, wherein the projection is formed on the top end face.

5. The flash discharge tube electrode of claim 1,
wherein the top end face further has a depressed part, and
wherein a part of the projection is embedded in the depressed part.

6. The flash discharge tube electrode of claim 1, wherein a part of the projection is embedded in the sintered electrode structure and the projection is in contact with the internal electrode.

7. The flash discharge tube electrode of claim 6, wherein an external diameter of the part of the projection embedded in the sintered electrode structure is smaller than an external diameter of a part exposed outside the sintered electrode structure.

8. A flash discharge tube,
wherein the flash discharge tube electrode of claim 1 is sealed to one end of the glass bulb and a rod-shaped electrode is sealed to the other end of the glass bulb,
wherein a transparent trigger electrode is provided on an entire outer circumferential surface of the glass bulb, and
wherein the inside of the glass bulb is filled with a noble gas.
